(19) United States
(12) Patent Application Publication
(10) Pub. No.: US 2018/0298990 A1
(43) Pub. Date: Oct. 18, 2018

(54) Transaxle Carrier Assembly

(71) Applicant: Ford Global Technologies, LLC, Dearborn, MI (US)

(72) Inventor: William F. Kinter, Plymouth, MI (US)

(21) Appl. No.: 15/485,959

(22) Filed: Apr. 12, 2017

(51) Int. Cl. F16H 3/66; F16H 57/08; B60K 17/08

(52) U.S. Cl. CPC F16H 3/66; F16H 57/082; B60K 17/08; F16H 2200/2007; F16H 2200/2082; F16H 2200/2012; F16H 2200/2046; F16H 2200/2066; F16H 2200/201

(57) ABSTRACT

A planet carrier, suitable for use in a transmission, is fastened to a ring gear by intermeshing axial teeth. The axial teeth convey torque between the carrier and the ring gear. A snap ring, inserted into a groove in the intermeshing teeth, holds the carrier and ring gear together axially. The carrier is formed from two plates, one of which is attached to an outer shell. Axial teeth are formed into the outer shell. One of the plates has tabs that are inserted into slots in the other plate.

### TECHNICAL FIELD

This disclosure related to the field of automotive transmissions. More particularly, the disclosure relates to a carrier assembly adapted for fixation to a shaft and a ring gear.

### BACKGROUND

Many vehicles are used over a wide range of vehicle speeds, including both forward and reverse movement. Some types of engines, however, are capable of operating efficiently only within a narrow range of speeds. Consequently, transmissions capable of efficiently transmitting power at a variety of speed ratios are frequently employed. When the vehicle is at low speed, the transmission is usually operated at a high speed ratio such that it multiplies the engine torque for improved acceleration. At high vehicle speed, operating the transmission at a low speed ratio permits an engine speed associated with quiet, fuel efficient cruising.

### SUMMARY

A carrier includes first and second plates and an outer shell. The first plate defines a set of slots. The outer shell has a first end rigidly fixed to the first plate and a series of axial teeth formed at a second end. The outer shell may have a first thickness adjacent to the first plate and a second, greater thickness at the axial teeth. The axial teeth define a snap ring groove. The second plate has a set of tabs inserted into the slots. The first and second plates are adapted to support opposite ends of a series of planet gear shafts. For example, each plate may define opposing holes to support opposite ends of the planet gear shafts. The outer shell may define windows aligned with the holes through which planet gears may be inserted during assembly.

A transmission includes first and second gearsets, each having a sun gear, a ring gear, and a carrier. A carrier of the first gearset has an outer shell with an open end terminating in a first set of axial teeth. A ring gear of the second gearset has a second series of axial teeth interleaved with the first set of axial teeth. A snap ring may be inserted into a groove defined in the first and second sets of axial teeth. The first carrier may also include first and second plates. The first plate may be rigidly fixed to the outer shell and may define a set of slots. The second plate may have a set of tabs inserted into the slots. The first and second plates may be adapted to support opposite ends of a set of planet gear shafts. An output element may be splined to an orifice defined in the second plate.

A method of assembling a transmission includes inserting tabs of a first plate into slots of a second plate, meshing a first set of axial teeth with a second set of axial teeth, and inserting a snap ring. The first and second plates form a carrier. The first set of axial teeth is part of an outer shell fixed to the second plate. The second set of axial teeth are fixed to a ring gear. The intermeshing teeth rotationally fix the ring gear to the carrier. The snap ring is inserted into a groove formed in the axial teeth and axially fixes the ring gear to the carrier. An output element may be inserted into a splined aperture in the first plate. Planet gears may be assembled to the carrier by inserting each planet gear through a window in the outer shell, inserting a planet gear shaft through the planet gear and through holes in the first and second plates, an securing the shaft to one of the plates.

### BRIEF DESCRIPTION OF THE DRAWINGS

FIG. 1 is a schematic diagram illustrating a transmission kinematic arrangement.

FIG. 2 is a first pictorial view of a carrier assembly suitable for use as one of the carrier in the kinematic arrangement of FIG. 1.

FIG. 3 is a second pictorial view of the carrier assembly of FIG. 2.

FIG. 4 is a cut-away view of the carrier assembly of FIG. 2 including a ring gear.

FIG. 5 is a flowchart for a process of assembling the transmission of FIG. 1, including the carrier assembly of FIGS. 2-4.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A group of rotatable elements are fixedly coupled to one another if they are constrained to rotate at the same speed about the same axis in all operating conditions. Rotatable elements may be fixedly coupled by, for example, spline connections, welding, press fitting, or machining from a common solid. Slight variations in rotational displacement between fixedly coupled elements may occur such as displacement due to lash or shaft compliance. In contrast, two rotatable elements are selectively coupled by a shift element when the shift element constrains them to rotate at the same speed about the same axis whenever the shift element is fully engaged and the rotatable elements are free to rotate at distinct speeds in at least some other operating condition. A shift element that selectively holds a rotatable element against rotation by selectively connecting it to the housing is called a brake. A shift element that selectively couples two or more rotatable elements to one another is called a clutch. Shift elements may be actively controlled devices such as hydraulically or electrically actuated clutches or brakes or may be passive devices such as one way clutches or brakes. Two rotatable elements are coupled if they are either fixedly coupled or selectively coupled.

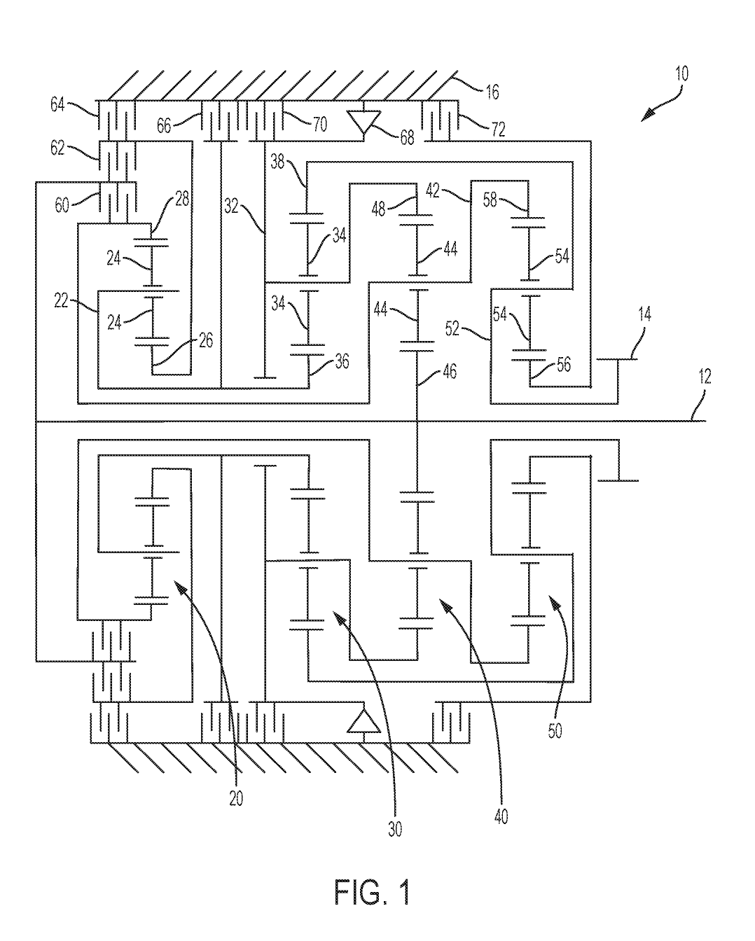

FIG. 1 schematically depicts a gearbox 10. This gearing arrangement provides a variety of fixed speed ratios between turbine shaft 12 and output element 14. Turbine shaft 12 is driven by a torque converter. Output element 14 may be a sprocket or a gear that transfers the power to a differential on a parallel axis. The gearbox is housed in housing 16 which does not rotate relative to vehicle structure.

The transaxle of FIG. 1 utilizes four simple planetary gear sets 20, 30, 40, and 50. Planet carriers 22, 32, 42, and 52 each rotate about a central axis and each support a set of planet gears 24, 34, 44, and 54 such that the planet gears rotate with respect to the respective planet carrier. External gear teeth on the planet gears mesh with external gear teeth on respective sun gears 26, 36, 46, and 56 and with internal gear teeth on respective ring gears 28, 38, 48 and 58. The sun gears and ring gears are supported to rotate about the same axis as the carriers. A suggested ratio of gear teeth for each planetary gear set is listed in Table 1.

TABLE 1

| | |
|---|---|
| Ring 28/Sun 26 | 1.83 |
| Ring 38/Sun 36 | 2.257 |
| Ring 48/Sun 46 | 2.70 |
| Ring 58/Sun 56 | 2.35 |

Sun gear 46 is fixedly coupled to turbine shaft 12. Ring gear 38 and carrier 52 are fixedly coupled to output element 14. Ring gear 28, carrier 42, and ring gear 58 are mutually fixedly coupled. Carrier 22 is fixedly coupled to sun gear 36. Carrier 32 is fixedly coupled to ring gear 48. Turbine shaft 12 is selectively coupled to ring gear 28 by clutch 60. Sun gear 26 is selectively coupled to turbine shaft 12 by clutch 62 and selectively held against rotation by brake 64. Carrier 22 and sun gear 36 are selectively held against rotation by brake 66. One way brake 68 permits carrier 32 to rotate in one direction but prevents rotation in the opposite direction. Brake 70 selectively holds carrier 32 against rotation in either direction. Finally, brake 72 selectively holds sun gear 56 against rotation.

As shown in Table 2, engaging the shift elements in specified combinations establishes eight forward speed ratios and one reverse speed ratio between turbine shaft 12 and output element 14. An X indicates that the shift element is required to establish the speed ratio. When the gear sets have tooth numbers as indicated in Table 1, the speed ratios have the values indicated in Table 2. In 1st gear, the transmission transfers power from turbine shaft 12 to first sprocket 14 but one way brake 68 overruns to prevent transfer of power in the opposite direction. The M1 state has the same speed ratio as 1st gear, but is capable of transferring power in either direction.

TABLE 2

| | 60 | 62 | 64 | 66 | 70 | 72 | Ratio | Step |
|---|---|---|---|---|---|---|---|---|
| Rev | | X | | | X | | −4.27 | 81% |
| M1 | | | | | X | X | 5.27 | |
| 1st | | | | | | X | 5.27 | |
| 2nd | | | | X | | X | 3.40 | 1.55 |
| 3rd | | | X | | | X | 2.64 | 1.29 |
| 4th | | X | | | | X | 2.04 | 1.29 |
| 5th | X | | | | | X | 1.43 | 1.43 |
| 6th | X | X | | | | | 1.00 | 1.43 |
| 7th | X | | X | | | | 0.87 | 1.16 |
| 8th | X | | | X | | | 0.69 | 1.25 |

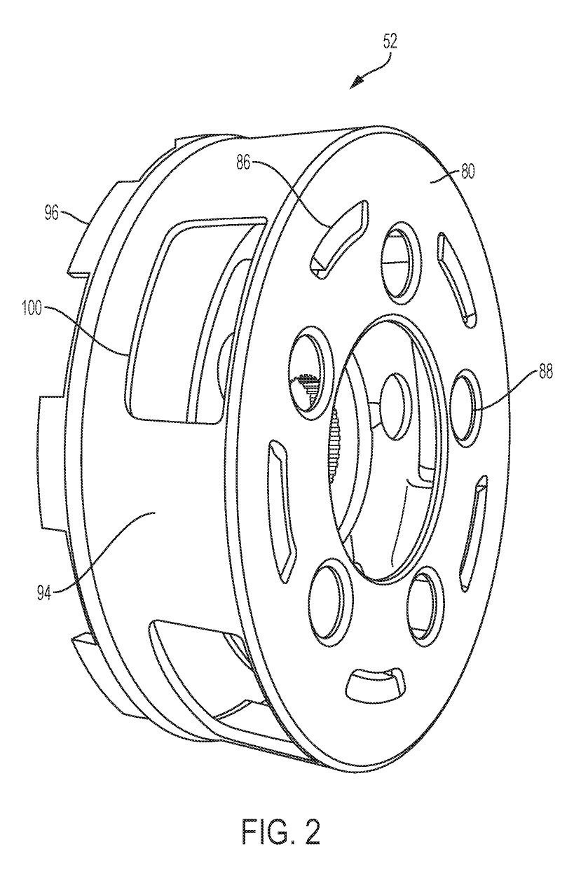

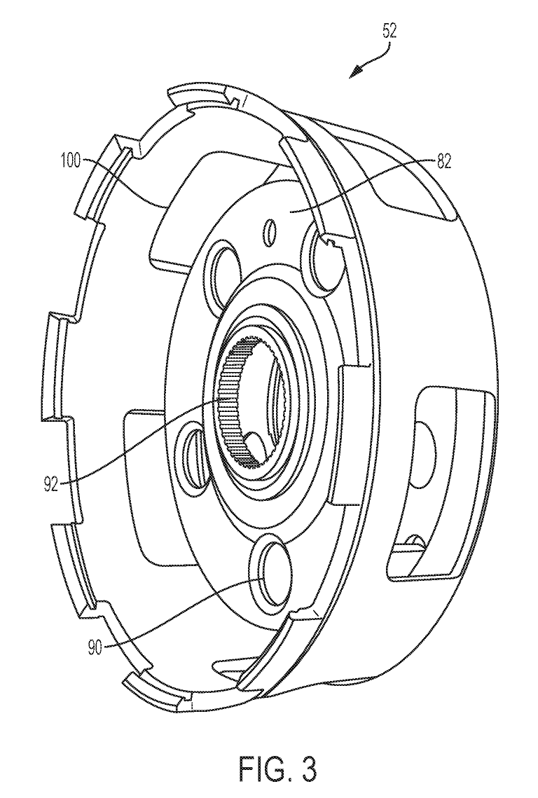

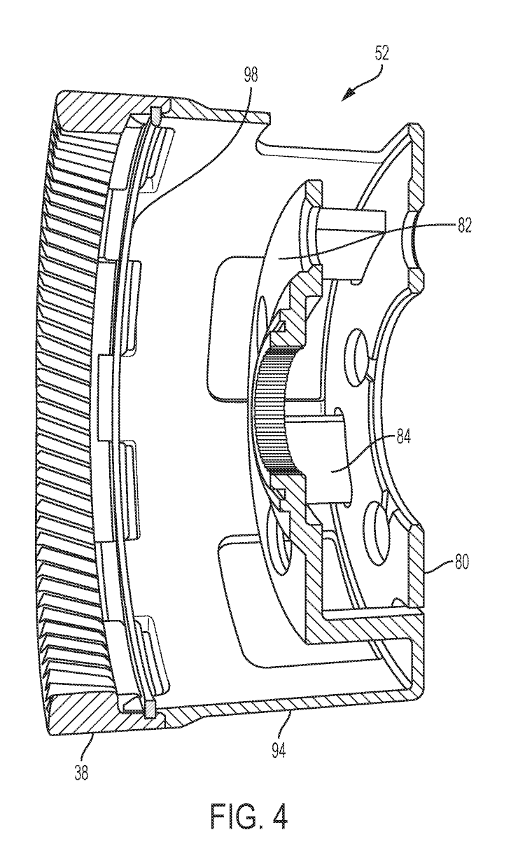

FIGS. 2-4 illustrate the structure of carrier 52. Carrier 52 includes first and second plates 80 and 82. Second plate 82 includes several tabs 84 (best seen in FIG. 4) which fit into a series of slots 86 in first plate 80 (best seen in FIG. 2). First plate 80 defines a plurality of holes 88 (best seen in FIG. 2) which are opposite a plurality of holes 90 defined in second plate 82 (best seen in FIG. 3). Holes 88 and 90 support opposite ends of a set of planet gear shafts (not shown). The planet gears 54 are supported on the planet gear shafts by roller bearings. Second plate 82 includes an inner aperature 92 with internal spline teeth. These spline teeth rotationally fix carrier 52 to output element 14.

FIG. 4 also illustrates how carrier 52 is attached to ring gear 38. A cylindrical outer shell 92 is fixed to first plate 80. For example, the first plate and the outer shell may be formed from common stock using a stamping process. On the opposite end from the first plate, the outer shell 92 has a number of axial teeth 94. Ring gear 38 also includes a number mating axial teeth that are interleaved with the axial teeth 94 of the outer shell. Torque is transmitted between carrier 52 and ring gear 38 by the side surfaces of these axial teeth. A snap ring 96 is inserted into a groove formed in the outer shell axial teeth and the ring gear axial teeth. The snap ring fixes the carrier 52 to the ring gear axially. The end section of the outer shaft may be slightly thicker than the remainder in order to leave sufficient material around the groove. Outer shell 92 includes a series of windows opposite the holes 88 and 90. In addition to reducing the mass and rotational inertia of the carrier, these windows facilitate assembly. Planet gears may be inserted into position from the perimeter through these windows.

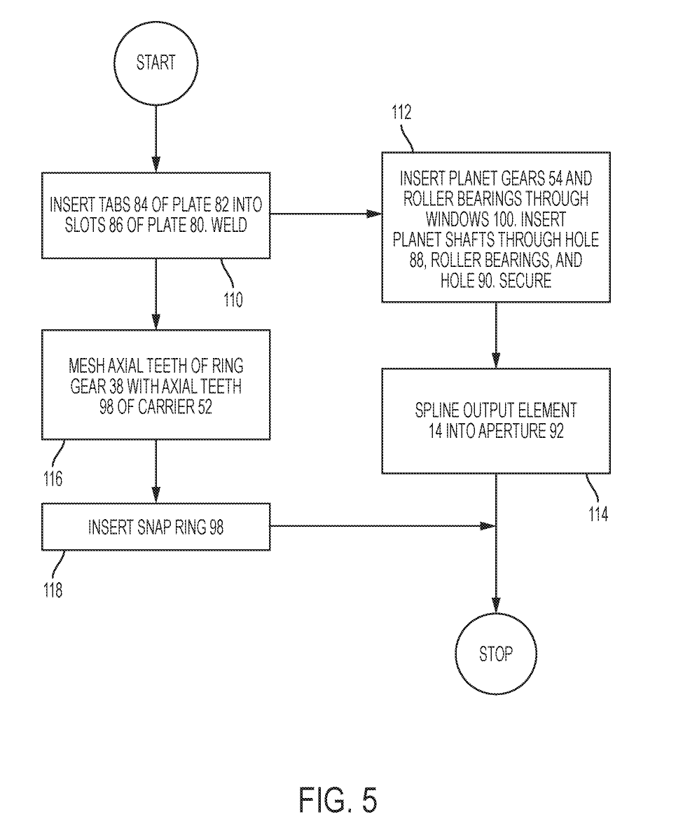

FIG. 5 is a flow chart for assembling the carrier 52, ring gear 38, and output element 14. To the extent possible, it is preferable to complete these steps before inserting the assembly into the transmission case 16. This flowchart does not indicate when to add other parts such as gearset 40, sun gear 52, and ring gear 58. Depending upon the relative diameter of these parts, it may be necessary to assemble some of them to carrier 52 prior to attaching ring gear 38.

At 110, the carrier itself is assembled by inserting the tabs 84 of second plate 82 into the slots 86 of first plate 80. These tabs are then permanently fixed in some manner such as welding. At 112, the planet gears 54 are assembled to the carrier 52. Prior to installation of the planet gears into the carrier, the roller bearings may be inserted into a cage which is inserted into the hollow planet gears. Then, the planet gears and bearings are inserted through windows 100 into position. Planet shafts are inserted through hole 88, the roller bearings, and hole 90, from either direction. The planet shafts are then fixed, for example, by snap rings. At 114, the output element 14 is attached to carrier 52 at the splined aperture 92.

At 116 and 118, ring gear 38 is attached to carrier 52. This may occur before or after the planet gears are installed and before or after the output element is installed. At 116, the axial teeth of ring gear 38 are meshed with the axial teeth 98 of carrier 52. Then, at 118, snap ring 98 is inserted into the groove formed in the axial teeth.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A carrier comprising:
a first plate defining a set of slots;
an outer shell having a first end rigidly fixed to the first plate, and a series of axial teeth formed at a second end of the outer shell and defining a snap ring groove; and
a second plate having a set of tabs inserted into the slots, the first and second plates adapted to support opposite ends of a series of planet gear shafts.

2. The carrier of claim 1 wherein the outer shell has a first thickness adjacent to the first plate and the axial teeth have a second thickness greater than the first thickness.

3. The carrier of claim 1 wherein:
the first plate defines a first plurality of holes to support first ends of the series of planet gear shafts; and
the second plate defines a second plurality of holes to support second ends of the series of planet gear shafts.

4. The carrier of claim 3 wherein the outer shell defines a plurality of windows, each of the windows aligned with one of the holes of the first plurality of holes and with one of the holes of the second plurality of holes.

5. A transmission comprising:
a first gearset having a first sun gear, a first ring gear; and a first carrier having an outer shell with an open end terminating in a first set of axial teeth; and
a second gearset having a second carrier, a second sun gear, and a second ring gear having a second series of axial teeth interleaved with the first set of axial teeth.

6. The transmission of claim 5 further comprising a snap ring inserted into a groove defined in the first and second sets of axial teeth.

7. The transmission of claim 6 wherein the first carrier further comprises:
a first plate rigidly fixed to the outer shell and defining a set of slots; and
a second plate having a set of tabs inserted into the slots, the first and second plates adapted to support opposite ends of a series of planet gear shafts.

8. The transmission of claim 7 further comprising an output element splined to an orifice defined in the second plate.

9. The transmission of claim 8 further comprising:
a third gearset having a third carrier fixedly coupled to the first ring gear, a third sun gear fixedly coupled to an input shaft, and a third ring gear fixedly coupled to the second carrier.

10. The transmission of claim 9 further comprising:
a fourth gearset having a fourth carrier fixedly coupled to the second sun gear, a fourth sun gear, and a fourth ring gear fixedly coupled to the third carrier.

11. A method of assembling a transmission comprising:
inserting tabs of a first plate into slots of a second plate, the second plate being fixed to an outer shell having a first set of axial teeth, the first and second plates forming a carrier;
meshing the first set of axial teeth with a second set of axial teeth fixed to a ring gear to rotationally fix the ring gear to the carrier; and
inserting a snap ring into a groove formed in the first and second set of axial teeth to axially fix the ring gear relative to the carrier.

12. The method of claim 11 further comprising inserting an output element into a splined aperture in the first plate to fixedly couple the output element to the first plate.

13. The method of claim 11 further comprising:
inserting a planet gear through a window defined in the outer shell;
inserting a planet gear shaft through the planet gear and through holes defined in the first and second plates; and
securing the planet gear shaft axially to one of the first and second plates.
